(19) United States
(12) Patent Application Publication
(10) Pub. No.: US 2025/0178822 A1
(43) Pub. Date: Jun. 5, 2025

(54) PREPACKAGED CHARGE OF EDIBLE MATERIAL POWDER, AND BEVERAGE PREPARATION SYSTEM USING SAID CHARGE

(71) Applicant: CAFFE PASCUCCI TORREFAZIONE S.P.A., Monte Cerignone (IT)

(72) Inventor: Bruno Bardazzi, Monte Cerignone (IT)

(21) Appl. No.: 18/845,175

(22) PCT Filed: Mar. 8, 2023
(86) PCT No.: PCT/IB2023/052185

§ 371 Date: Sep. 9, 2024

(30) Foreign Application Priority Data
Mar. 8, 2022 (IT) 102022000004358

(51) Int. Cl. B65D 85/804; A23F 5/26; A47J 31/06; A47J 31/36; A47J 31/40; B65D 65/46

(52) U.S. Cl. CPC B65D 85/8043; A23F 5/26; A47J 31/0668; A47J 31/3623; A47J 31/407; B65D 65/466

(57) ABSTRACT

Prepackaged charge of edible material powder for use in a beverage preparation system, comprising a rigid container body made of paper or cardboard, comprising a continuous side wall and a bottom wall made of piece with each other, obtained by processing vegetable fiber pulp derived from waste from the primary processing of seasonal crops such as sugarcane, rice cotton, hemp, sorghum, bamboo or the like, alone or in composition with each other, in which Kappa number of the vegetable fiber pulp is less than 2, and in which the walls of said container body are made in such a way that at least one face of said walls is continuous and compact, while the other face is discontinuous and wrinkled are capable of acting as a filter upon use, allowing the passage of infusion.

### TEXT OF THE DESCRIPTION

The present invention relates to prepackaged charges intended for use in beverage preparation systems, and to beverage preparation systems using such charges.

The field of beverage preparation machines, and specifically for home use, has literally exploded in the last two decades, and particularly in what concerns espresso machines. Accordingly, on the one hand, a lot of technology has been developed concerning the functionality of prepackaged charges, so as to implement their effectiveness in extracting the brew and the ease of insertion and ejection. Of course, the expansion of the market for prepackaged coffee powder charges has led to an abnormal production of the corresponding waste, which in most cases includes a considerable percentage of non-biodegradable material, typically the container body of the prepackaged charge, and thus has a very high environmental impact.

The lowest environmental impact solution is, of course, one that involves a container body made of a flexible material, such as filter paper or similar, which is by its nature biodegradable and also generally compostable. However, this type of container is not mechanically stable, and can create problems during both insertion and ejection. Document WO2015105409 describes a so-called pod whose container body has at least one wall provided with shape retention means. This development is intended to improve the mechanical features of pods, but the result is rather limited.

On the other hand, document WO2018002223 describes the container body of a pre-packaged charge of coffee powder made from compostable material, specifically a mixture of sugarcane fiber pulp and bamboo fiber pulp. This container body was modeled on the construction, and operation, of one of the most popular beverage preparation systems, and specifically coffee, namely Nestlé's Nespresso® system. The high level of market uptake led to envisioning a new compostable container that would be compatible with that system. The result is pre-packaged charges in which the material from which the container body is made has been substituted, but which are applied to the same functional model. The consequence is that the use of such prepackaged charges in systems that operate differently, e.g., in which the extraction water flow through the capsule from the open inlet to the bottom wall of the container body is not even imagined. In addition, no consideration is given to not perforating the walls of the container body, so as to limit the loss of liquid and powdered material.

In European Patent EP3530153 owned by the same applicant, a pre-packaged charge for use in hot beverage preparation systems is described, the container body of which is made of vegetable pulp fiber derived from the processing scraps of seasonal crops such as sugarcane, hemp, rice, cotton, bamboo or the like, the lignin content being less than 5%; the walls of said container body are able to act as a filter under the conditions of use, i.e., during coffee extraction.

As it is evident from the executive examples provided in the patent for capsules made from sugarcane fiber pulp (also known as bagasse), the container body of the capsules is able to act as a filter once the infusion liquid has soaked its walls. Thus, this type of material has the ability to allow the infusion to pass through, retaining particulate matter and maintaining structural integrity to allow the expulsion of the exhausted prepacked charge. Permeation of the infusion through the walls of the container body is achieved by working the surface of the container body walls, which have one face that is continuous and compact and the other face that is discontinuous and wrinkled. In addition, plastic deformation of at least one wall of the container body is provided so as to promote permeation.

However, capsules of the type that was tested in this patent have wide room for improvement, particularly in relation to the mechanical characteristics of the container body of the prepackaged charge, which can be improved in both mechanical strength and lightness.

In addition, the research leading to the development of the present invention investigated those structural features that favor the behavior of the container body in the sense suggested by the above-mentioned prior patent of the same applicant; for this purpose, the characteristics of vegetable fiber pulps used for making the container body were verified, and in particular, the so-called Kappa number (UNI ISO 302 2015), which in the paper industry is recognized as the index for evaluating the lignin content of a vegetable fiber pulp material, was evaluated. The value of Kappa is between 1 and 100; the higher the Kappa number of a pulp, the higher the lignin content.

Front document US2022/064867 describes a paper intended for use in hot extractions, such as those of coffee or tea, that is made from pulp obtained from tree chips, both coniferous and deciduous trees, treated by the Kraft process until a pulp with a Kappa number that can be even less than 5 is obtained. The pulps thus obtained have long fibers, a low lignin content, and make it possible to produce a paper with significant air permeability, as well as improved mechanical performance precisely in relation to the low lignin content and fiber characteristics. However, the processing of wood chips using the Kraft process, and the subsequent treatments for obtaining a low Kappa number negatively impact the eco-sustainability of this product, which, moreover, as the examples show, is designed primarily to make pods and not containers.

It should also be considered that pulps derived from seasonal crop scraps have an undoubted advantage in terms of abundance and availability. Numerous studies are known at the state of the art showing the relative ease of processing various types of waste from seasonal crops to obtain pulps with low or very low lignin content and capable of providing high-performance paper products (“Energy varieties of sugar cane as a novel source fiber for the cellulose and paper industry” Triana, O. et al (Appita Journal, 2008); “SODA-AQ PULPING OF COTTON STALKS” Mona, A. et al (TAPPI Conference, 2001); “Cationic-modified PVA as a dry strength additive for rice straw fibers” Fatehi, P. et al (Bioresource Technology, 2008); “Alkaline Sulfite Anthraquinone and Methanol Pulping of Bamboo (Gigantochloa scortechinii)” Moradbak, A. et al (Bioresources, 2016)).

Thus, the aim of the present invention is to improve the structural characteristics and functionality of compostable container bodies for prepacked charges of the type described above by obtaining a lighter, thinner but also stronger container body by selecting an appropriate composition of vegetable fiber pulp from processing waste of seasonal crops.

An object of the present invention is a pre-packaged charge of edible material powder for use in a beverage preparation system, comprising a rigid container body made of paper or cardboard, comprising a continuous side wall and a bottom wall made integral with each other, obtained by processing vegetable fiber pulp derived from waste from the primary processing of seasonal crops such as sugarcane rice, cotton, hemp, sorghum, bamboo or the like, either alone or in composition with each other, in which the Kappa number of the vegetable fiber pulp is less than 2, and in which the walls of said container body are made in such a way that at least one face of said walls is continuous and compact, while the other face is discontinuous and wrinkled and are able to act as a filter during use, allowing the passage of infusion. Preferably, during use at least one wall of the container body is subjected to plastic deformation without causing it to break.

The vegetable fiber pulp used to form the container body is preferably a composition of vegetable fiber pulps comprising so-called sugarcane bagasse, in a percentage ranging from 30% to 100% by weight, and one or more vegetable fiber pulps chosen from bamboo, hemp, rice or cotton, in a percentage ranging from 70% to 0%. Advantageously, the composition includes 30% to 70% sugarcane bagasse and 70% to 30% bamboo pulp; preferably the composition includes 50% sugarcane bagasse and 50% bamboo pulp.

The choice of introducing bamboo pulp into the composition of vegetable fiber pulps descends from the significant increase found in mechanical properties, and in particular in elongation and tensile energy absorption (T.E.A.); this increase can be attributed to a different fiber size distribution in the composition including bamboo.

In general, it can be said that the vegetable fiber pulp used to make the container body according to the present invention has fibers that for a fraction between 5% and 35%, and preferably between 7% and 30%, are greater than or equal to 1.3 mm in length. The fibers are also wider than 16.00 μm for a fraction between 30% and 70%, and preferably between 40% and 60%.

In a variant of the invention, a waterproofing additive, such as alkyl ketene dimers (AKDs) and in particular AK-15, i.e., derivatives of 2-Oxethanone, 3-C12-16-alkyl-4-C13-17-alkylidene, is added to the vegetable pulp. This additive is preferred because of its effectiveness as a waterproofing agent, its almost complete biodegradability, and its insignificant toxicity. The additive is added at the rate of 2-5% by weight of the vegetable pulp, and preferably 3%.

In a preferred embodiment of the invention, the container body is made by hot pressure molding. Advantageously, the only bottom wall of the container body has a discontinuous and rough outer face.

The container body of the prepackaged charge according to the invention may have a grammage, i.e., the ratio of weight to surface area, between 250 and 600 g/m², and preferably between 300 and 500 g/m². The wall thickness of the container body is between 0.3 mm and 1.0 mm, and preferably between 0.4 mm and 0.7 mm. The density of the container body is in the range between 0.2 g/cm³ and 1.0 g/cm³, and preferably between 0.4 g/cm3 and 0.8 g/cm³. The container body made according to the invention has a high permeability to air as measured by the Gurley method, expressed in seconds that a given volume of air takes to pass through a paper sample; this permeability is in the range of 10 to 60 seconds, and particularly in the range of 15 to 50 seconds.

It is further an object of the present invention to provide a system for the preparation of beverages comprising a prepackaged charge of powder of edible material, and an infusion assembly adapted to cooperate with said prepackaged charge, wherein said prepackaged charge is of the type described above, and wherein said infusion assembly comprises an infusion chamber whose bottom wall is provided with a plurality of conduits communicating with the dispensing means, each of said conduits being positioned at a relief or recess capable of causing a plastic deformation in the bottom wall of the container body of the prepackaged charge without causing a rupture of said wall, thereby allowing the flow of infused beverage to pass through said wall, which acts in this way as a filter. Particularly relevant is the delay that is induced to the passage of the infused stream, due to the time it takes for the wall of the container body to absorb the liquid to allow it to pass through, and which actually enhances the infusion itself, ensuring the so-called “cream effect.”

Advantageously, each relief or recess has a height, or depth, that does not exceed 2.5 mm; also, each relief or recess has a cross section that does not exceed 10.0 mm. In a preferred alternative embodiment, the bottom wall is provided with a plurality of circular axial recesses, each centrally provided with an axial conduit for communication with the dispensing means.

In another embodiment of the system according to the present invention, the bottom wall of the infusion chamber is movable, and provided with elastic loading means, so as to facilitate ejection of the exhausted prepackaged charge at the end of the infusion. Advantageously, the bottom wall can be removable, and different bottom walls can be provided for the same infusion assembly, so as to make the best use of the interaction between the container body and the infusion chamber wall to optimize the extraction of the edible substance present within the prepacked charge. In particular, the smaller the size of cavities or reliefs, the slower the extraction will be, and consequently a different infusion chamber bottom wall can be used depending on the type of infusion to be performed.

Further advantages and features of the prepackaged charge according to the present invention, as well as of the beverage preparation system intended to use such a charge, will be apparent from the following description of some embodiments of the same invention, rendered, for illustrative and non-limiting purposes, with reference to the accompanying tables of drawings, in which:

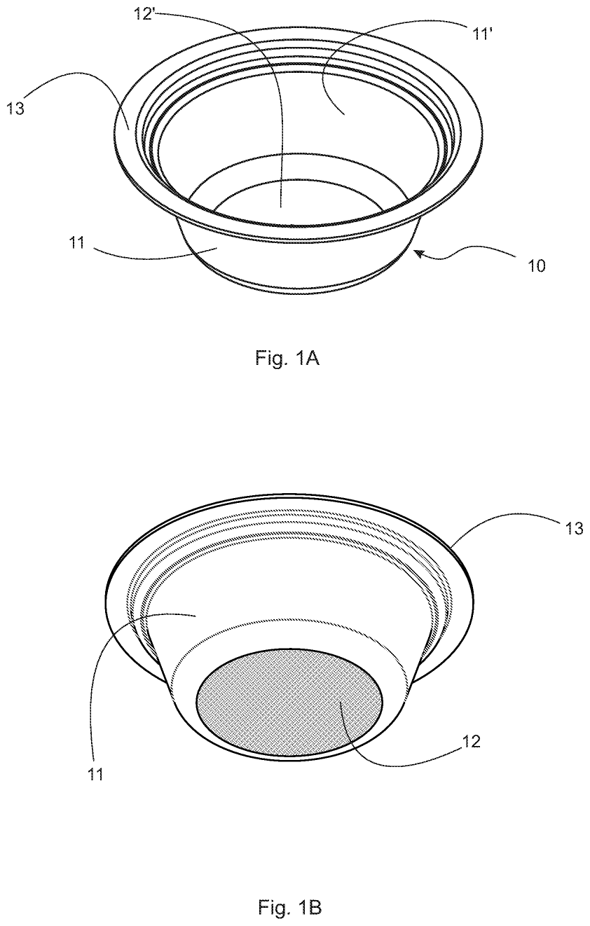

FIGS. 1A and 1B are perspective views, from above and below, respectively, of the container body of a prepackaged charge according to the present invention;

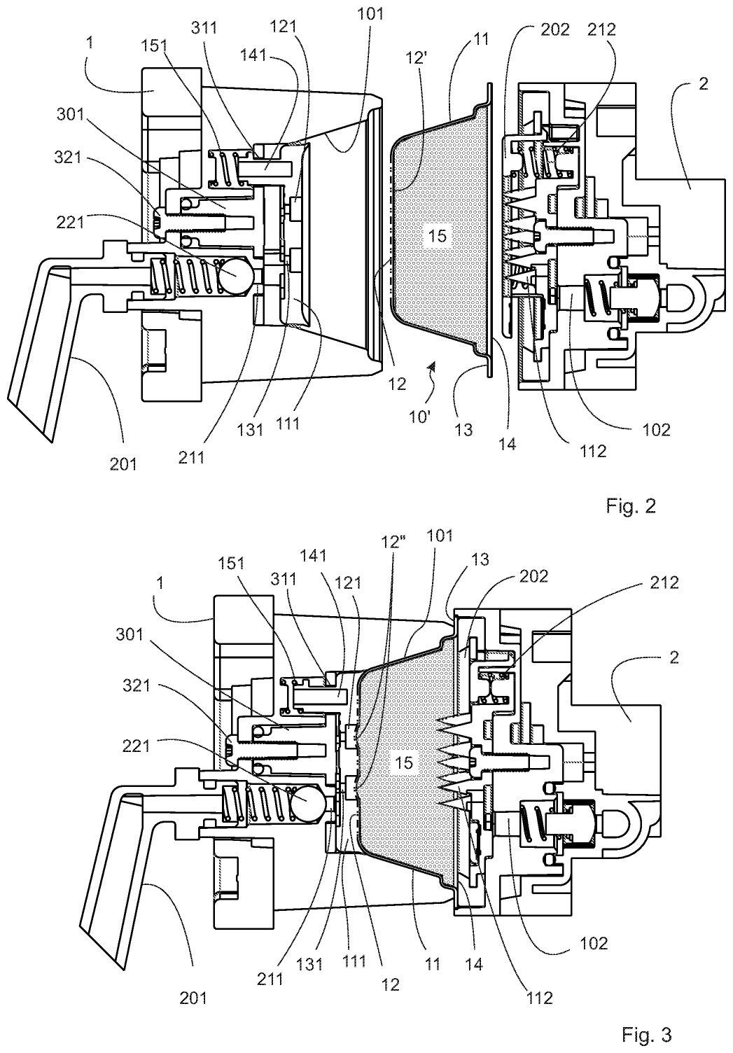

FIG. 2 is a cross-sectional view of a detail of the beverage preparation system according to the present invention, illustrated when the prepackaged charge is introduced into the infusion assembly;

FIG. 3 is a sectional view similar to that in FIG. 2, in which the system according to the invention is illustrated in the beverage extraction stage;

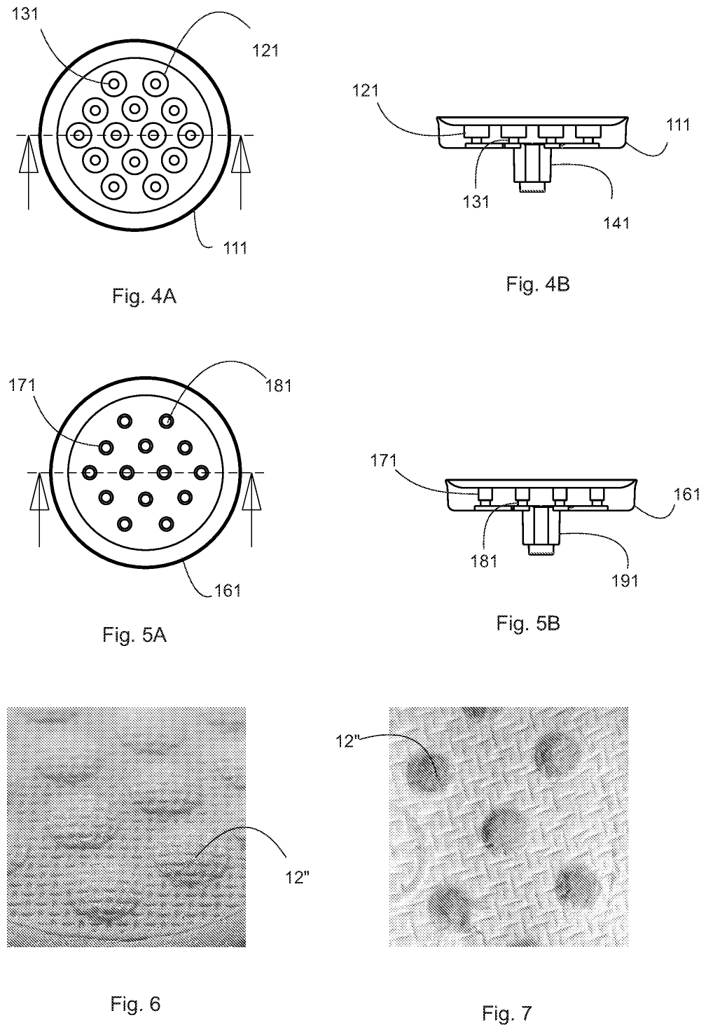

FIG. 4A is a plan view from above of the bottom wall of the infusion chamber of the system in FIG. 2;

FIG. 4B is a cross-sectional view of the bottom wall of FIG. 4A.

FIGS. 5A and 5B are similar views to those in FIGS. 4A and 4B relating to an alternative embodiment of the system according to the invention;

FIG. 6 is a photograph relating to a detail of the bottom wall of a prepackaged charge according to an alternative embodiment of the present invention, at the end of dispensing of the beverage;

FIG. 7 is a photograph relating to a detail of the bottom wall of a prepackaged charge according to another executive variant of the present invention, at the end of dispensing of the beverage;

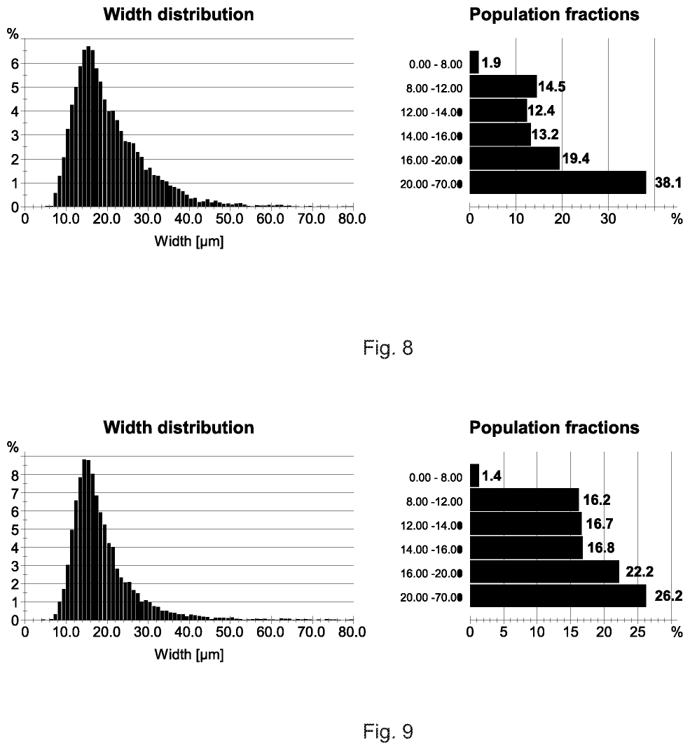

FIGS. 8 and 9 are diagrams illustrating the distribution of fiber fractions with respect to their width, in both execution variants illustrated in FIGS. 5 and 6;

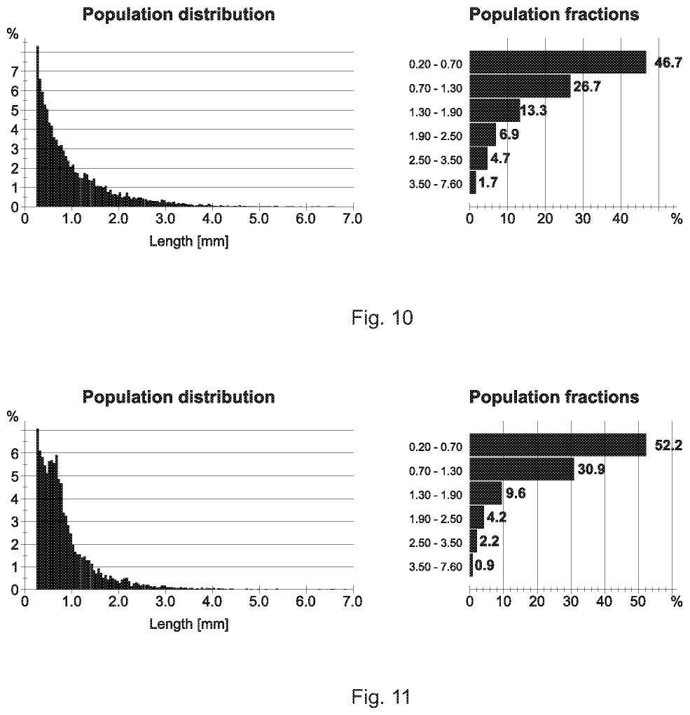

FIGS. 10 and 11 are diagrams illustrating the distribution of fiber fractions with respect to their length, in both execution variants illustrated in FIGS. 6 and 7.

An embodiment of the container body of the prepackaged charge according to the present invention is shown in FIG. 1A; 10 indicates the container body, which has the outer face 11 of the frustoconical side wall, as well as the inner face 11′, and as the inner face 12′ of the back wall, with a continuous and compact finish, while, as is evidenced by FIG. 1B, the outer face 12 of the back wall has a discontinuous and wrinkled finish. The open end of container body 10 has a projecting radial flange 13, provided on both faces with a compact finish.

The choice of the realization of the container body with these characteristics descends from the need on the one hand to optimize the containment and storage capacity of the edible material, and in particular of the coffee. The continuous and compact surface inside the container body makes it possible to reduce the permeation of oils through the walls, while the rough finish on the back wall only favors the diffusion of the infusion, once the appropriate deformations have taken place, as better illustrated, and described below. Nevertheless, it should still be considered the fact that the container body could be permeated by the infusion flow without any need for deformation if at least the inner face of the bottom wall was wrinkled and discontinuous, as is evident from what is described and illustrated in the prior owner's patent, as cited above.

An embodiment of the system according to the invention is illustrated in FIG. 2; the prepackaged charge 10′ is shown as it is introduced into the infusion assembly, formed by the fixed portion 1 and the movable portion 2. The prepackaged charge 10′ includes the container body 10 as described above, the edible powdered material, specifically coffee powder 15, and the closure plane 14. The fixed portion 1 of the infusion assembly includes the infusion chamber 101, the back wall of which comprises a plate 111 having a plurality of cylindrical cavities 121 axially provided with conduits 131. The plate 111 has an axial stem 141, which passes through the hole 311 formed on the cap 301 and on said cap it rests, under the thrust of the spring 151. Cap 301 is secured to the fixed portion 1 of the infusion assembly by means of the screw 321. The dispensing nozzle 201 communicates with the infusion chamber 101 via duct 211, which is controlled by valve 221. In fact, plate 111 is thus not only movable, since it thus allows the charge 10′ to be ejected at the end of the infusion, but it is also removable, and consequently different plates can be used in the same infusion assembly, depending on the type of infusion to be achieved. By varying the shape or size of the cavities, as shown, for example, in FIGS. 4A, 5A below better described, a faster or slower infusion can be obtained, and thus in the case more suitable for espresso or tea or herbal tea, respectively.

The movable portion 2 includes the means 102 of feeding pressurized hot water through the injectors 112 designed to penetrate the closure plane 14, and is also equipped with an ejecting member 202 elastically charged by the spring 212, which allows the injectors 112 to be pulled out of the closure plane 14, and thus the exhausted prepackaged charge to be pushed away from the infusion unit, at the end of the beverage extraction process.

FIG. 3 illustrates the infusion system of FIG. 2 during beverage extraction; equal parts correspond to equal numerals. Highlighted in the figure is the fact that deformations 12″ were produced on the bottom wall of the container body 10 of the prepacked charge at the cavities 121 of plate 111. The deformations 12″ do not affect the integrity of the bottom wall of the container body, but allow the brew produced to pass through the wall, which in this case works as a filter, preventing the dispersion of the coffee powder 15.

FIGS. 4A and 4B show in greater detail the plate 111, i.e., the movable back wall of the infusion chamber 101; equal parts correspond to equal numerals; FIG. 4A shows the arrangement of the 121 cavities and their respective 131 ducts, while FIG. 4B shows the size of the 121 cavities and 131 ducts. Similarly, plate 161 shown in FIGS. 5A and 5B shows cavities 171, which are significantly smaller in diameter than the cavities 121 in plate 111 described above. Varying the size of the cavities may vary the degree of deformation of the bottom wall of the container body, and thus affect the rate of infusion dispensing. More specifically, a larger cavity size will correspond to greater deformation and thus greater wall permeability; consequently, smaller cavities will be useful for obtaining infusions that require a longer extraction time.

The structure and operation of the prepackaged charge according to the present invention, as well as the operation of the beverage preparation system using it, will appear evident from what follows. As mentioned in the introduction, the research leading to the present invention descends directly from that leading to the aforementioned patent EP3530153 and is its natural development. In the following executive examples, the connection between the structure of the material used to implement the container body of the prepackaged charge and the operation of the beverage preparation system comprising said charge is evaluated.

### EXAMPLE 1: CONTAINER BODY MADE OF SUGARCANE BAGASSE PULP

First of all, it was therefore appropriate to more specifically characterize the material used in the previous research, and to this end, careful analyses were conducted on container bodies made from only sugarcane bagasse.

Measurements were then made regarding grammage, i.e., weight per surface area (UNI EN ISO 536), thickness and density (UNI EN ISO 534), and air permeability, using the Gurley method (UNI ISO 5636-5). The results for the ten samples analyzed are shown below in Table 1.

TABLE 1

| | | | | Permeability |
|---|---|---|---|---|
| | Grammage | Thickness | Density | (Gurley) |
| | (g/m²) | (μm) | (g/cm³) | (s) |
| | 480 | 672 | 0.714 | 53 |
| | 505 | 657 | 0.769 | 40 |
| | 490 | 729 | 0.672 | 55 |
| | 470 | 700 | 0.671 | 60 |
| | 465 | 655 | 0.710 | 50 |
| | 490 | 684 | 0.716 | 48 |
| | 510 | 651 | 0.783 | 44 |
| | 490 | 684 | 0.716 | 48 |
| | 450 | 705 | 0.638 | 52 |
| | 450 | 646 | 0.697 | 50 |
| Average | 480 | 678 | 0.709 | 50 |

The mechanical properties of the container bodies were then tested by evaluating their tensile properties both dry (UNI EN ISO 1924-2) and after immersion in water (ISO 3781). Table 2 below shows the data for the dry tests, while Table 3 shows the data for the wet tests.

TABLE 2

| | Dry tensile properties | | | |
|---|---|---|---|---|
| | Tensile | | | Tensile |
| | strength | Elongation | T.E.A. | index |
| | (kN/m) | (%) | (J/m²) | (kN/m*kg) |
| | 7.65 | 1.65 | 60.06 | 15.6 |
| | 8.13 | 1.27 | 56.62 | 17.7 |
| | 8.17 | 1.28 | 63.78 | 17.8 |
| | 7.75 | 1.28 | 53.95 | 15.8 |
| | 7.25 | 1.42 | 63.99 | 15.3 |
| | 7.00 | 1.09 | 64.64 | 14.7 |
| | 8.80 | 2.03 | 79.24 | 18.1 |
| | 9.40 | 1.62 | 82.27 | 19.2 |
| | 9.00 | 1.55 | 70.55 | 17.6 |
| | 7.45 | 1.05 | 51.69 | 14.9 |
| Average | 8.06 | 1.42 | 64.68 | 16.7 |

TABLE 3

| | Wet tensile properties | | | Wet |
|---|---|---|---|---|
| | Tensile | | | relative |
| | strength | Elongation | T.E.A. | strength |
| | (kN/m) | (%) | (J/m²) | % |
| | 2.26 | 2.53 | 52.52 | 30 |
| | 2.05 | 2.38 | 39.58 | 25 |
| | 2.18 | 2.61 | 45.52 | 27 |
| | 2.16 | 2.12 | 38.82 | 28 |
| | 1.95 | 2.29 | 35.26 | 27 |
| | 2.59 | 2.21 | 42.37 | 37 |
| | 1.8 | 2.14 | 30.06 | 20 |
| | 1.88 | 1.97 | 30.87 | 20 |
| | 2.5 | 1.98 | 41.87 | 28 |
| | 2.16 | 2.49 | 48.17 | 29 |
| MEDIA | 2.15 | 2.27 | 40.50 | 27 |

Of course, in addition to the physical and mechanical properties of the samples, a number of chemical characteristics relevant to this field were also measured, such as the degree of whiteness (UNI ISO 2470-2) the aforementioned Kappa number, and the determination of soluble, insoluble and total lignin content (ISO CD 21436). The relevant data are shown in Table 4 below.

TABLE 4

| | Brightness | Lignin | Lignin | Lignin | |
|---|---|---|---|---|---|
| | D65/10° | (insoluble) | (soluble) | (total) | Kappa |
| | (%) | (%) | (%) | (%) | number |
| | 79.81 | 12.00 | <0.1% | 12.00 | 1.52 |
| | 79.42 | 13.60 | <0.1% | 13.60 | 1.56 |
| | 79.48 | | | | |
| | 80.62 | | | | |
| | 80.86 | | | | |
| | 79.27 | | | | |
| | 80.57 | | | | |
| | 80.02 | | | | |
| | 79.98 | | | | |
| | 79.25 | | | | |
| Average | 79.93 | 12.80 | | 12.80 | 1.54 |

A due consideration in the margin of the latter findings must be spent with regard to the relevance of these data; in fact, while the Kappa number is a decidedly well-established system of controlling the lignin content of pulps intended for papermaking, the direct determination of the percentage of lignin is a method still in process of being developed, and therefore endowed with a more reduced reliability. It is apparent from the very organization of the test standard that pulps with a content above or below 5 should be clearly divided from the point of view of the same analysis. The pulps used to make the container body of the prepackaged charge according to the present invention undoubtedly fall within those with a Kappa number of less than 5, and in particular less than 2.

In addition, fiber mixture analysis was carried out with an automated optical analyzer using polarized light (TAPPI T271). Among the data obtained, those relating to the distribution of fiber width, with related populations (see FIG. 9 of the attached drawings) and those relating to the distribution of fiber length, with related populations (see FIG. 11 of the attached drawings) were considered particularly relevant to the development of the present invention. To be taken into consideration is the fact that 16.9 percent of fibers in the analyzed sample are at least 1.3 mm long and 48.4 percent of fibers are more than 16.0 μm wide.

Finally, a container body of the type analyzed above, and made as illustrated in FIGS. 1A and 1B, was used to pack a charge of coffee powder, which was introduced into an infusion unit of the type shown in FIGS. 2 and 3, provided on the bottom wall of the infusion chamber with 18 circular cavities, 3.0 mm in diameter and 1.5 mm deep, with axial ducts of 0.8 mm in cross section. As shown in the photograph in FIG. 7, the deformations did not cause the bottom wall of the container body to break. The infusion was also optimal from the point of view of speed, with an excellent organoleptic result; sediment in the normal range.

### EXAMPLE 2: CONTAINER BODY MADE OF SUGARCANE BAGASSE PULP AND BAMBOO FIBER PULP

In this case, a composition of 50% by weight sugarcane bagasse pulp and 50% by weight bamboo fiber pulp was used for the preparation of the container bodies, to which 3% of the total weight of the composition of AK-15, i.e., the derivatives of 2-Oxethanone, 3-C12-16-alkyl-4-C13-17-alkylidene, was added.

The container bodies, made as shown in FIGS. 1A and 1B, were then subjected to the same analytical tests as in Example 1. The relevant data are shown below in Tables 5 through 8.

Fiber mixture analysis was also performed on these samples, and the outcomes of fiber distributions by width and length, respectively, are shown in FIGS. 8 and 10 of the attached drawings, similar to what was evaluated in Example 1. In the data shown in the figures, it should be noted that in this case fibers longer than 1.3 mm were 26.6 percent of the total fibers, and fibers wider than 16.0 μm were 57.5 percent of the total fibers.

TABLE 5

| | | | | Permeability |
|---|---|---|---|---|
| | Grammage | Thickness | Density | (Gurley) |
| | (g/m²) | (μm) | (g/cm³) | (s) |
| | 330 | 523 | 0.631 | 19 |
| | 348 | 599 | 0.581 | 16 |
| | 355 | 529 | 0.671 | 18 |
| | 336 | 595 | 0.565 | 17 |
| | 330 | 576 | 0.573 | 15 |
| | 340 | 549 | 0.619 | |
| | 340 | 597 | 0.570 | |
| | 332 | 528 | 0.629 | |
| | 345 | 534 | 0.646 | |
| | 340 | 600 | 0.567 | |
| Average | 340 | 563 | 0.605 | 17 |

TABLE 6

| | Dry Tensile Properties | | | |
|---|---|---|---|---|
| | Tensile strength | Elongation | T.E.A. | Tensile index |
| | (kN/m) | (%) | (J/m²) | (kN/m*kg) |
| | 17.67 | 6.44 | 768.90 | 39.70 |
| | 16.78 | 7.30 | 819.40 | 36.80 |
| | 15.45 | 7.65 | 567.30 | 368.00 |
| | 14.20 | 7.98 | 922.90 | 31.60 |
| | 13.81 | 6.85 | 643.20 | 32.90 |
| | 16.32 | 6.37 | 610.50 | 36.30 |
| | 14.83 | 6.47 | 553.90 | 35.30 |
| | 17.61 | 7.13 | 904.30 | 39.10 |
| | 18.95 | 6.83 | 833.20 | 44.60 |
| | 17.80 | 7.33 | 850.70 | 39.70 |
| Average | 16.34 | 7.04 | 747.43 | 37.30 |

TABLE 7

| | | | | Wet |
|---|---|---|---|---|
| | Wet tensile properties | | | relative |
| | Tensile strength | Elongation | T.E.A. | strength |
| | (kN/m) | (%) | (J/m²) | % |
| | 4.15 | 10.77 | 357.70 | 23 |
| | 4.53 | 9.38 | 356.00 | 27 |
| | 4.34 | 9.27 | 311.50 | 28 |
| | 3.15 | 8.08 | 209.00 | 22 |
| | 3.91 | 9.05 | 258.00 | 28 |
| | 4.31 | 9.17 | 318.00 | 26 |
| | 4.83 | 9.50 | 392.00 | 33 |
| | 4.80 | 10.09 | 357.80 | 27 |
| | 4.75 | 9.50 | 340.30 | 25 |
| | 3.29 | 9.39 | 259.00 | 18 |
| Average | 4.21 | 9.42 | 315.93 | 26 |

TABLE 8

| | Brightness | Lignin | Lignin | Lignin | |
|---|---|---|---|---|---|
| | D65/10° | (insoluble) | (soluble) | (total) | Kappa |
| | (%) | (%) | (%) | (%) | number |
| | 80.21 | 10.20 | <0.1% | 10.20 | 1.41 |
| | 80.79 | 12.40 | <0.1% | 12.40 | 1.43 |
| | 80.10 | | | | |
| | 80.19 | | | | |
| | 81.99 | | | | |
| | 80.91 | | | | |
| | 81.06 | | | | |
| | 82.01 | | | | |
| | 82.31 | | | | |
| | 82.35 | | | | |
| Average | 81.19 | 11.30 | | 11.30 | 1.42 |

Again, coffee was brewed with a prepackaged charge using a container body of the type described above. The prepackaged charge was placed in an infusion assembly with the bottom wall of the infusion chamber the same as that shown in FIG. 4A, with 14 circular cavities 4.00 mm wide and 2.00 mm deep. As it is evident from the image in FIG. 6, the bottom wall of the container body appears even less deformed than verified for the container body in Example 1; and this is even though the cavities have larger diameters and depths, and in particular equal to the diameter and depth of the cavities on the bottom wall in Comparative Example 2 of the same applicant's prior patent.

When comparing the outcomes of the two examples above, it is evident that there are undoubted similarities between the two materials used, namely those related to the data in Tables 4 and 8, with degree of whiteness, lignin content and Kappa number definitely in the same ranges. In this case, the most striking finding is that both materials have a Kappa number significantly less than 5, and in particular less than 2. This leads one to consider useful for the purposes of the invention those pulps from plant fiber processing waste from seasonal crops that have a significantly reduced lignin content.

In addition, it should be taken into account that the time required for the infusion to permeate the wall of the container body and thus reach the dispensing means constitutes that certain “delay” necessary, in the case of coffee brewing, for obtaining the best conditions for having the optimal infusion, i.e., the one with the so-called “cream effect.”

However, comparing the data in Table 1 with those in Table 5 leads us to find that the container body of Example 2 is lighter, thinner, and more permeable to air than that of Example 1. In particular, the air permeability of the material in Example 2 is comparable to that shown by the paper described in US2022064867 previously cited, despite the fact that the material in Example 2 has a much more substantial grammage.

The differences are highlighted by comparing the results of the fiber size distribution analysis of FIGS. 8 to 11. Indeed, it can be appreciated that the fibers of the composition comprising sugarcane bagasse and bamboo fiber pulp have larger fractions of longer and wider fibers.

This difference becomes appreciable when comparing the mechanical performance data of the two different materials. Comparing the dry strength and elongation, it jumps out that the material in Example 2 has much higher values in both cases. The same consideration can be made for the same data on the sample in the wet condition, while the only substantially similar data is the relative strength in the wet condition. It is worth noting that the resulting elongation figure for the material in Example 2 is comparable to, and indeed on average higher than, that stated for the material in the earlier document US2022064867 cited in the introduction, despite the fact that the average fiber size is considerably smaller.

It should come as no surprise at this point that although a bottom wall of the infusion chamber with cavities that would have led to the rupture of the container body of Example 1 was used, the 12″ deformations in FIG. 6 appear less marked than those in FIG. 7, precisely because the material used has a higher mechanical strength.

On the infusion of the prepackaged charge of Example 2, the analysis on the presence of metals was also performed, showing extremely low concentrations of metals considered potentially toxic, such as Cd, Co, Cr, Ni and Zn. Table 9 shows the data from the analysis conducted on the coffee infusion.

In addition, the screening conducted with reference to microplastics, i.e., particles of plastic matter between 0.1 μm and 5.0 mm, found that, compared with an infusion water in which 14 microplastic particles out of 100 particles were present, with a size distribution between 35 μm and 300 μm, in the infusion the microplastics present were 2 out of 100 particles, with a size distribution between 55 μm and 90 μm. The filtering effectiveness of the walls of the container body is particularly emphasized in this respect.

TABLE 9

| | Detected |
|---|---|
| Element | quantity (mg/kg) |
| As | <0.005 |
| Cd | <0.005 |
| Hg | <0.005 |
| Pb | <0.005 |
| Cu | 0.095 ± 0.042 |
| Zn | 0.135 ± 0.058 |
| Fe | 0.509 ± 0.180 |
| Co | 0.008 ± 0.004 |
| Cr | <0.005 |
| Mn | 0.542 ± 0.190 |
| Ni | 0.043 ± 0.019 |
| Sn | <0.005 |
| Al | 0.882 ± 0.288 |
| Sb | <0.005 |
| B | 0.544 ± 0.191 |
| V | <0.005 |

However, the results of these findings, which clearly cannot be solely attributed to the filtering action of the container body's walls, make it possible to state that the material used to make the container body not only does not contain or release harmful or potentially toxic metals, but is probably capable of sequestering them from the infusion to some degree.

Prepackaged charges designed in this way combine the advantages of a product that is fully compostable once exhausted with those of a stable container body whose walls are able of acting as a filter upon use, with no risk of breakage or leakage of the material they contain.

1. Prepackaged charge of edible material powder for use in a beverage preparation system, comprising a rigid container body (10) made of paper or cardboard, comprising a continuous side wall (11, 11′) and a bottom wall (12, 12′) made integral with each other, obtained by processing vegetable fiber pulp derived from waste from the primary processing of seasonal crops such as sugarcane, rice, cotton, hemp, sorghum, bamboo or the like, alone or in composition with each other, in which the Kappa number of the vegetable fiber pulp is less than 2, and in which the walls of said container body are made in such a way that at least one face (11, 12′) of said walls is continuous and compact, while the other face (12) is discontinuous and wrinkled, and are able of acting as a filter during use, allowing the passage of infusion.

2. Prepackaged charge according to claim 1, in which during use at least one wall (12, 12′) of the container body is subjected to plastic deformation (12″), without causing it to break.

3. Prepackaged charge according to claim 1, in which the vegetable fiber pulp used to form the container body is a composition of vegetable fiber pulps including so-called sugarcane bagasse, in a percentage ranging from 30% to 100% by weight, and one or more vegetable fiber pulps chosen from bamboo, hemp, rice or cotton, in a percentage ranging from 70% to 0%.

4. Prepackaged charge according to claim 3, where the composition includes 30% to 70% of sugarcane bagasse and 70% to 30% of bamboo pulp.

5. Prepackaged charge according to claim 4, where the composition includes 50% of sugarcane bagasse and 50% of bamboo pulp.

6. Prepackaged charge according to claim 1, in which the vegetable fiber pulp used to make the container body has fibers that for a fraction between 5% and 35%, and preferably between 7% and 30%, are greater than or equal to 1.3 mm in length, and in which the fibers are more than 16.00 μm wide for a fraction between 30% and 70%, and preferably between 40% and 60%.

7. Prepackaged charge according to claim 1, in which only the bottom wall of the container body has a discontinuous and wrinkled outer face.

8. Prepackaged charge according to claim 1, in which the container body has a grammage, i.e., the ratio of weight to surface area, between 250 and 600 g/m².

9. Prepackaged charge according to claim 1, in which the wall thickness of the container body is between 0.3 mm and 1.0 mm, and preferably between 0.4 mm and 0.7 mm.

10. Prepackaged charge according to claim 1, in which the density of the container body is in the range of 0.2 g/cm³ to 1.0 g/cm³, and preferably between 0.4 g/cm³ and 0.8 g/cm³.

11. A beverage preparation system comprising a prepackaged charge (10′) of powder of edible material, and an infusion assembly (1, 2) adapted to cooperate with said prepackaged charge, wherein said prepackaged charge is a prepackaged charge of edible material powder for use in a beverage preparation system, comprising a rigid container body (10) made of paper or cardboard, comprising a continuous side wall (11, 11′) and a bottom wall (12, 12′) made integral with each other, obtained by processing vegetable fiber pulp derived from waste from the primary processing of seasonal crops such as sugarcane, rice, cotton, hemp, sorghum, bamboo or the like, alone or in composition with each other, in which the Kappa number of the vegetable fiber pulp is less than 2, and in which the walls of said container body are made in such a way that at least one face (11, 12′) of said walls is continuous and compact, while the other face (12) is discontinuous and wrinkled, and are able of acting as a filter during use, allowing the passage of infusion, and wherein said infusion assembly (1, 2) comprises an infusion chamber (101) whose bottom wall (111; 161) is provided with a plurality of conduits (131; 181) communicating with the dispensing means (201), each of said conduits (131; 181) being positioned at a relief or recess (121; 171) capable of causing a plastic deformation (12″) in the bottom wall (12, 12′) of the container body (10) of the prepackaged charge without causing a break of said wall, thereby allowing the flow of infused beverage to pass through said wall, which acts in this way as a filter.

12. System according to claim 11, in which each relief or recess (121; 171) of said bottom wall (111; 161) of the infusion chamber (101) has a height, or depth, that does not exceed 2.5 mm.

13. System according to claim 11, in which each relief or recess (121; 171) of said bottom wall (111; 161) of the infusion chamber has a cross section not exceeding 10.0 mm.

14. System according to claim 11, wherein the bottom wall (111; 161) of said infusion chamber is provided with a plurality of circular axial cavities (121; 171), each centrally provided with an axial conduit (131; 181) for communication with the dispensing means (201).

15. System according to claim 11, in which the bottom wall (111; 161) of the infusion chamber (101) is movable, and equipped with elastic loading means (151).

16. System according to claim 11, in which the bottom wall (111; 161) is removable, and several bottom walls (111; 161) are provided for the same infusion assembly (1, 2).
